(19) United States
(12) Patent Application Publication
(10) Pub. No.: US 2002/0040769 A1
(43) Pub. Date: Apr. 11, 2002

(54) Double sided dispenser

(76) Inventor: Chiwu Huang, Taipei (TW)

Correspondence Address: BANNER & WITCOFF, LTD., 28 STATE STREET, 28th FLOOR, BOSTON, MA, 02109, US

(21) Appl. No.: 09/911,837

(22) Filed: Jul. 24, 2001

Related U.S. Application Data
(60) Provisional application No. 60/222,118, filed on Jul. 28, 2000.

(51) Int. Cl. B65C 11/04

(52) U.S. Cl. 156/578; 156/579

(57) ABSTRACT

Disclosed is a double sided dispenser in a single hand-held unit, which; in one embodiment thereof, includes one end that dispenses correction transfer film, and the other end dispenses a transparent, colored highlighting film. In another embodiment, two different sizes of films are dispensed at each end of the unit, and these films may each be of the transfer correction film type, or one may be a correction film and the other a highlighting film, or the like.

### CROSS-REFERENCE TO RELATED APPLICATION

This application claims priority under 35 U.S.C. 119(e) from a copending Provisional Application, U.S. Ser. No. 60/222,118, filed Jul. 28, 2000, the disclosure of which is hereby incorporated herein by reference.

### BACKGROUND OF THE INVENTION

Dispensers for correction transfer films are well known in the art. See, for example U.S. Pat. Nos. 4,671,687, 5,397,477, 5,556,469, 5,785,437, 5,792,263, and 6,062,286, the disclosures of which are hereby incorporated herein by reference. The components of the correction film dispensers of the prior art generally are made of plastic materials and may include small metal components, as they are generally designed to be disposable once the film supply has been exhausted.

### SUMMARY OF THE INVENTION

The present invention is related to the correction film dispensers of the prior art, but represents an improvement there over. The present invention provides a double sided dispenser in a single hand-held unit, which; in one embodiment thereof, includes one end that dispenses correction film, and the other end dispenses a transparent, colored highlighting film. In another embodiment, two different sizes of films are dispensed at each end of the unit, and these films may each be of the transfer correction film type, or one may be a correction film and the other a highlighting film, or the like.

### BRIEF DESCRIPTION OF THE DRAWINGS

FIG. 1 shows an exploded view of the double-sided dispenser of the present invention, with the tapes omitted for clarity.

FIG. 2 shows the first stage of interacting reels and wheels used in the construction of the double-sided dispenser of the present invention.

FIG. 3 shows the second stage of interacting reels and wheels used in the construction of the double-sided dispenser of the present invention.

FIG. 4, in views 4A, 4B, 4C and 4D, shows in cross-section (4A, 4B, 4C) the arrangement of several component parts of the double-sided dispenser of the present invention. View 4D of this figure is a cross-sectional view from the top of the dispenser.

FIG. 5 is a plan view of the outside case of the double-sided dispenser of the present invention.

FIG. 6 is a bottom view of the outside case of the double-sided dispenser of the present invention.

FIG. 7 shows details regarding the outside case (or housing) of the double-sided dispenser of the present invention.

FIG. 8 shows details regarding the inside of the housing of the double-sided dispenser of the present invention.

FIGS. 9A and 9B are cross-sectional views taken along section line A-A in FIG. 7.

FIG. 10 is a cross-sectional view taken along section line B-B in FIG. 7.

FIG. 11 is a cross-sectional view taken along section line C-C in FIG. 7.

FIG. 12 is a cross-sectional view taken along section line D-D in FIG. 8.

FIG. 13 is a cross-sectional view taken along section line E-E in FIG. 8.

FIG. 14 is a close-up view of the region marked “F” in FIG. 8.

FIG. 15 is a close-up view of the region marked “G” in FIG. 8.

FIG. 16 is a close-up view of the region marked “H” in FIG. 8.

FIG. 17 is a close-up view of the region marked “I” in FIG. 8.

FIG. 18 is a cross-sectional view of the end of FIG. 7.

FIGS. 19A, 19B and 19C show details regarding internal components of the double-sided dispenser of the present invention.

FIGS. 20A and 20B show details regarding internal components of the double-sided dispenser of the p resent invention.

FIGS. 21A, 21B, 21C and 21D show details regarding internal components of the double-sided dispenser of the present invention.

FIGS. 22A, 22B, 22C and 22D show details regarding internal components of the double-sided dispenser of the present invention.

FIG. 23 is an X-ray view from the topside of the double-sided dispenser of the present invention.

FIG. 24 is an X-ray view from the bottom side of the double-sided dispenser of the present invention.

FIGS. 25 and 26 are X-ray views from each end of the double-sided dispenser of the present invention.

FIG. 27 is an X-ray view from the flat side of the double-sided dispenser of the present invention.

### DETAILED DESCRIPTION OF THE PREFERRED EMBODIMENTS

The present invention provides a double-sided dispenser for correction films, highlighting films, and the like. As illustrated in the figures accompanying this specification, the dispenser of the present invention has a two-piece housing into which the various components for each operational end of the device are mounted. The housing is preferably sized to fit conveniently in the hand of the user, but both very large units (e.g., for use before large audiences) and very small units (e.g., key-chain size—as a promotional give-away) may also be made following the teachings of this invention.

Advantageously the entire assembly (except the films) is made from inexpensive plastic components, but if desired, any one or all of the components can be made from metal or combinations of metal and plastics.

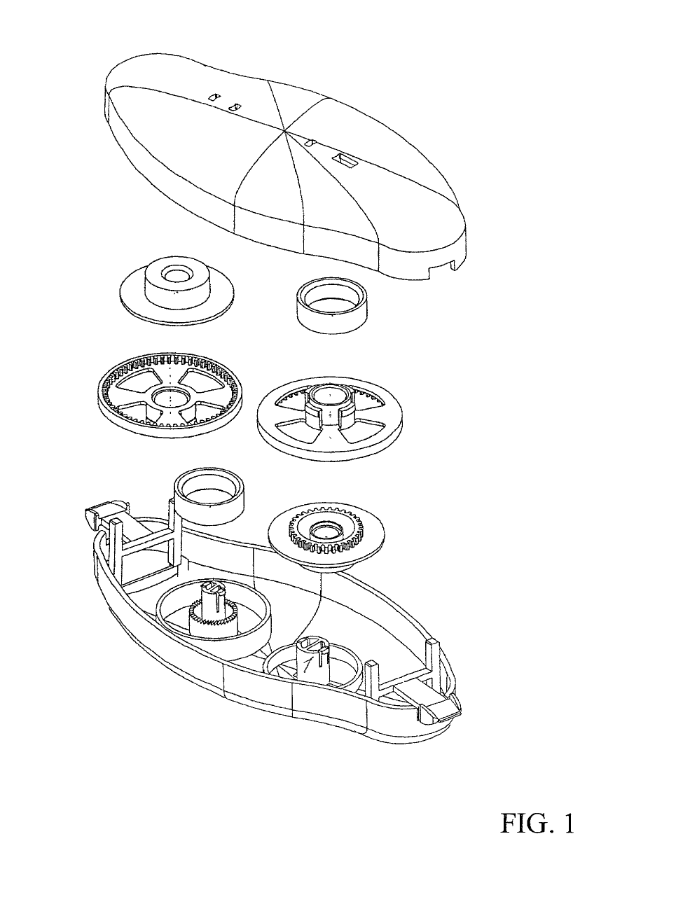

FIG. 1 shows an exploded view of the double-sided dispenser of the present invention, with the tapes omitted for clarity. As shown therein, the housing consists of two parts, and within the housing there are mounted the various geared wheels and gear driven rolls which serve as the dispensing and take-up means for the two types of transfer film to be disposed in the housing.

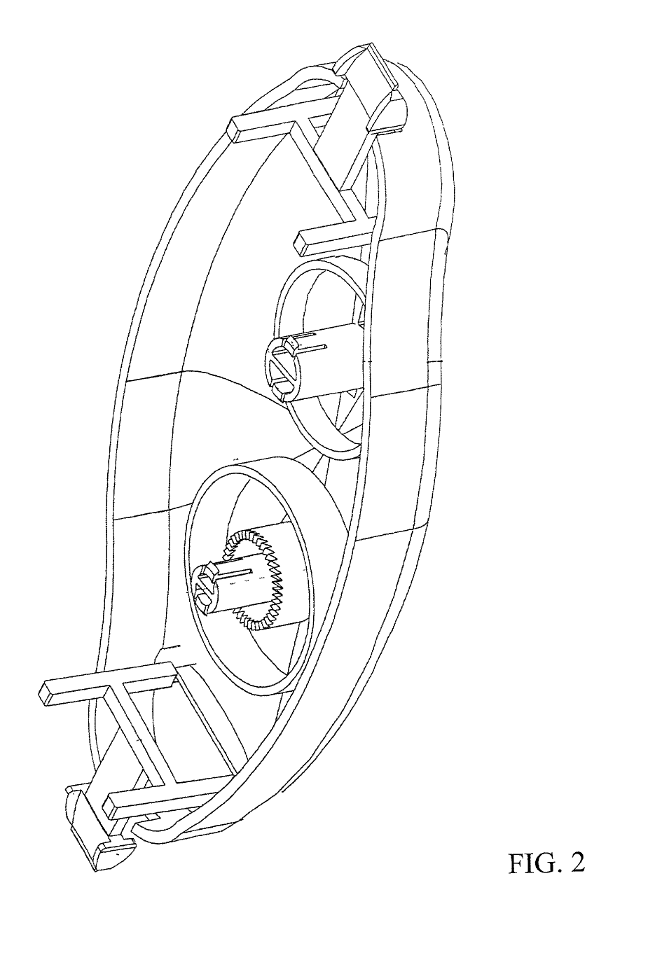

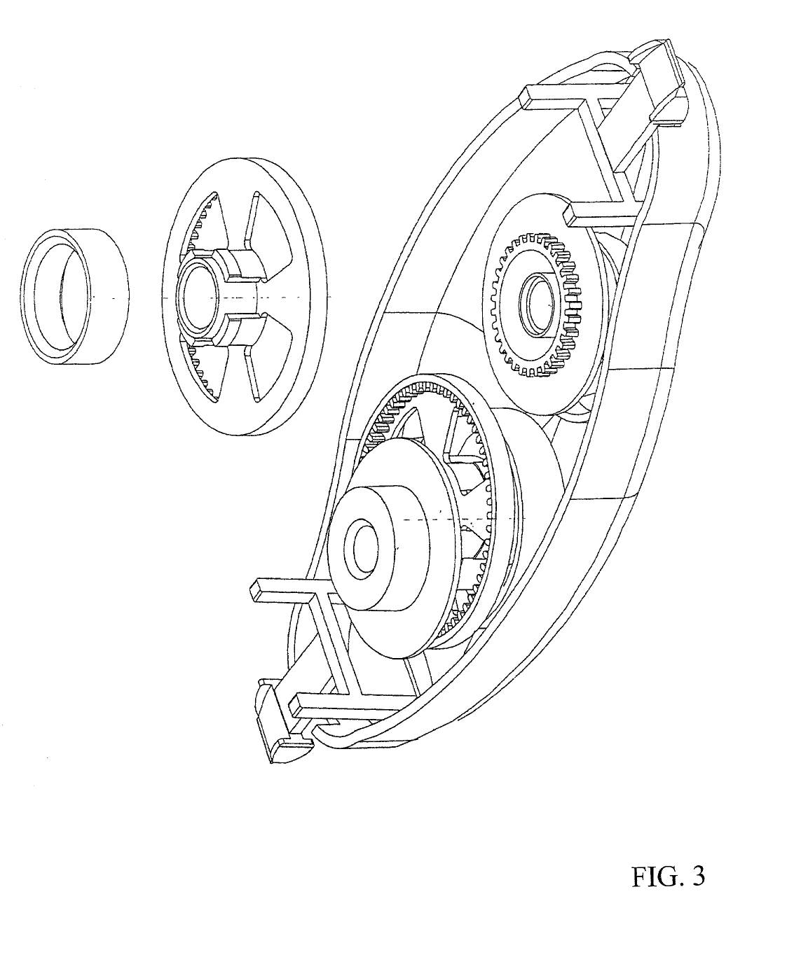

FIG. 2 shows the first stage of interacting reels and wheels used in the construction of the double-sided dispenser of the present invention. FIG. 3 shows the second stage of interacting reels and wheels used in the construction of the double-sided dispenser of the present invention.

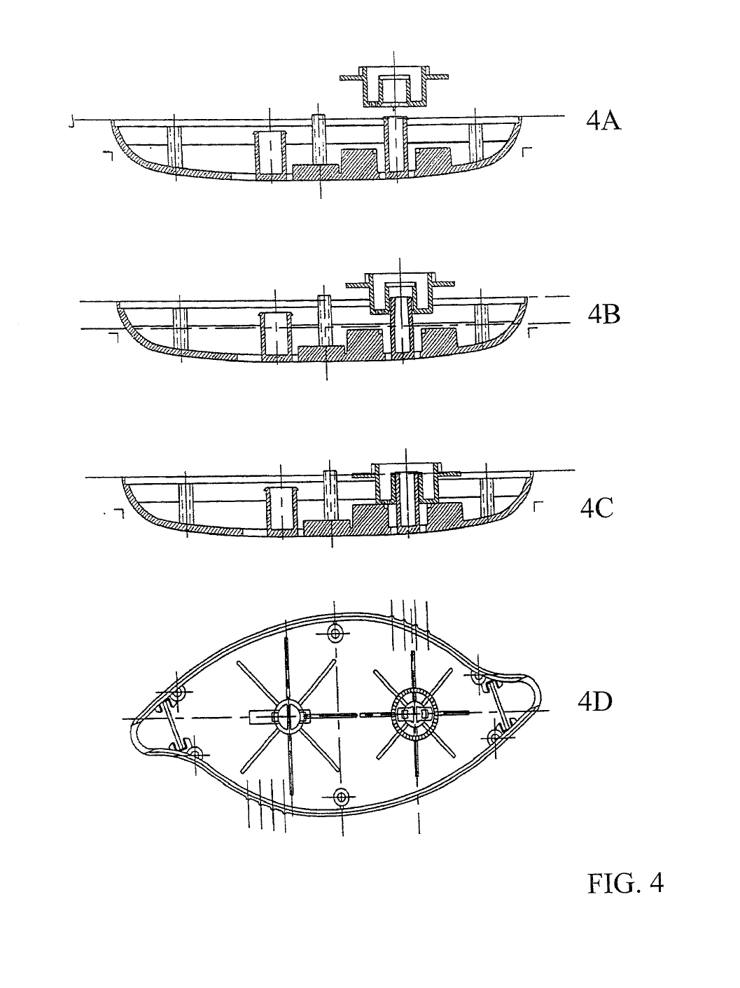

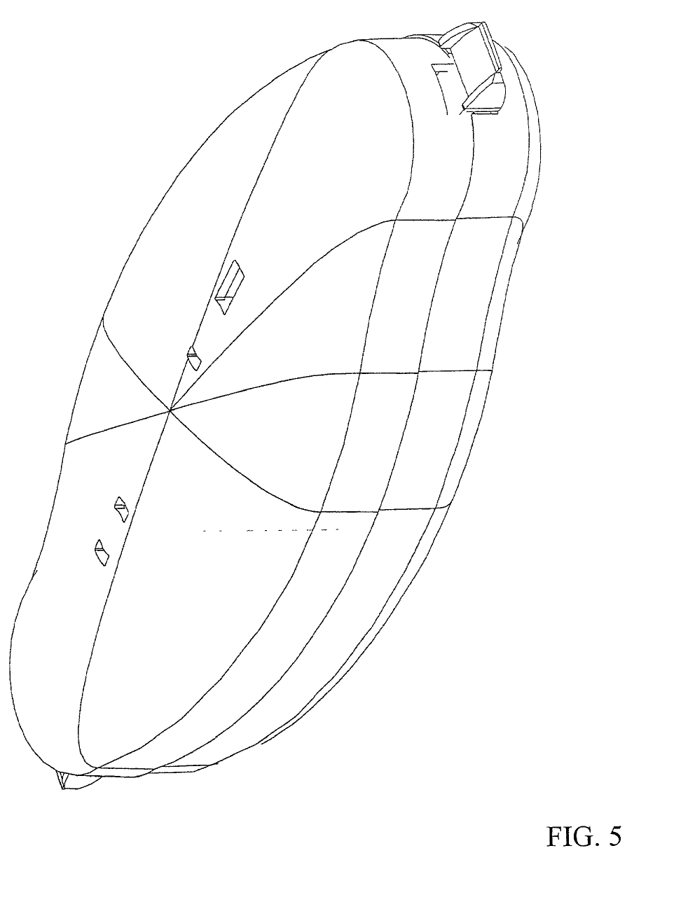

FIG. 4, in views 4A, 4B, 4C and 4D, shows in cross-section (4A, 4B, 4C) the arrangement of several component parts of the double-sided dispenser of the present invention. View 4D of this figure is a cross-sectional view from the top of the dispenser.

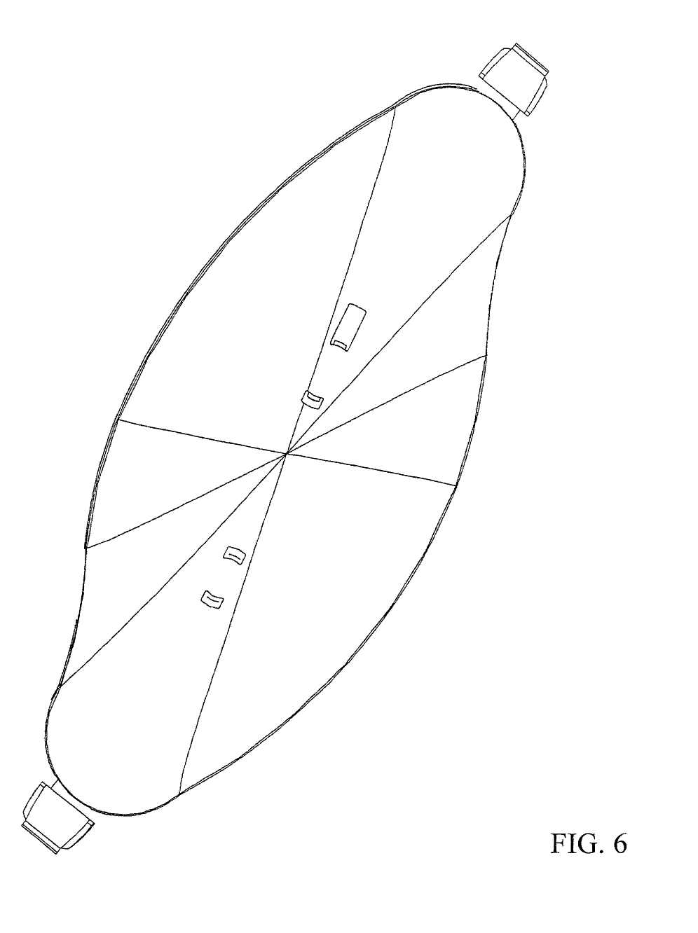

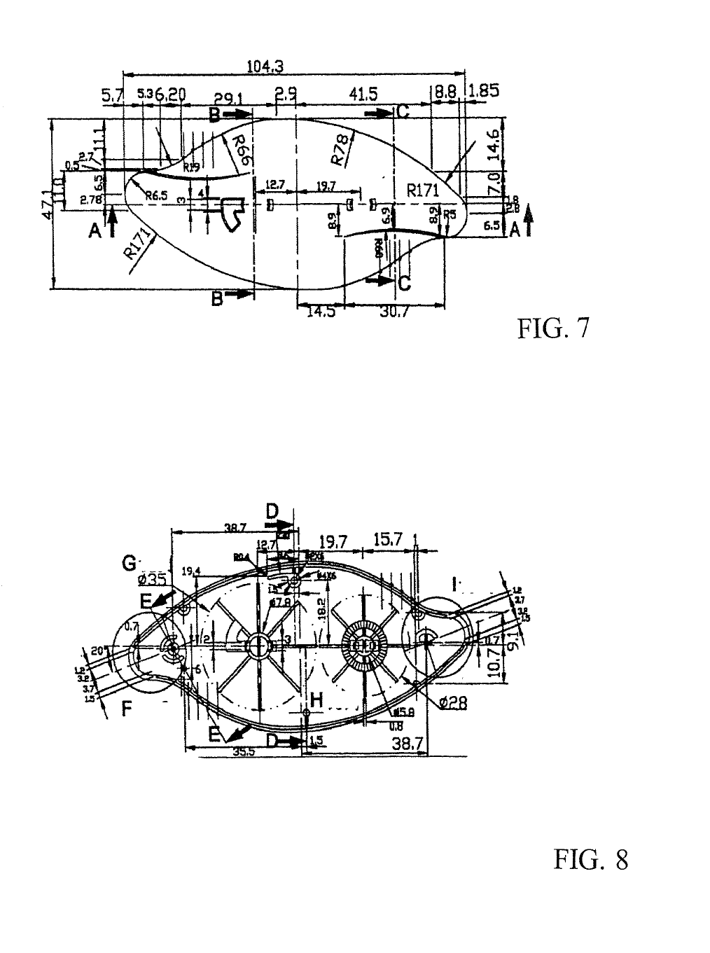

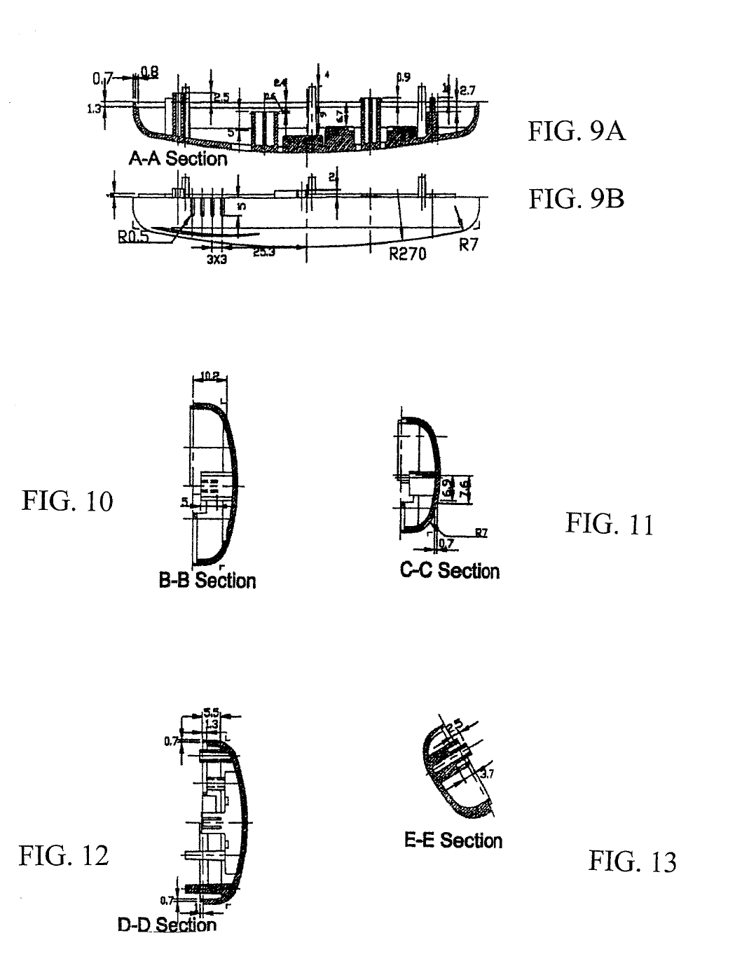

FIG. 7 shows details regarding the outside case (or housing) of the double-sided dispenser of the present invention. Dimensions are given in standard units (e.g., mm) and radii are marked by the letter “R”. FIGS. 9A and 9B are cross-sectional views taken along section line A-A in FIG. 7. FIG. 10 is a cross-sectional view taken along section line B-B in FIG. 7. FIG. 1 is a cross-sectional view taken along section line C-C in FIG. 7.

FIG. 8 shows details regarding the inside of the housing of the double-sided dispenser of the present invention. As above, dimensions are given in standard units (e.g., mm). FIG. 12 is a cross-sectional view taken along section line D-D in FIG. 8. FIG. 13 is a cross-sectional view taken along section line E-E in FIG. 8.

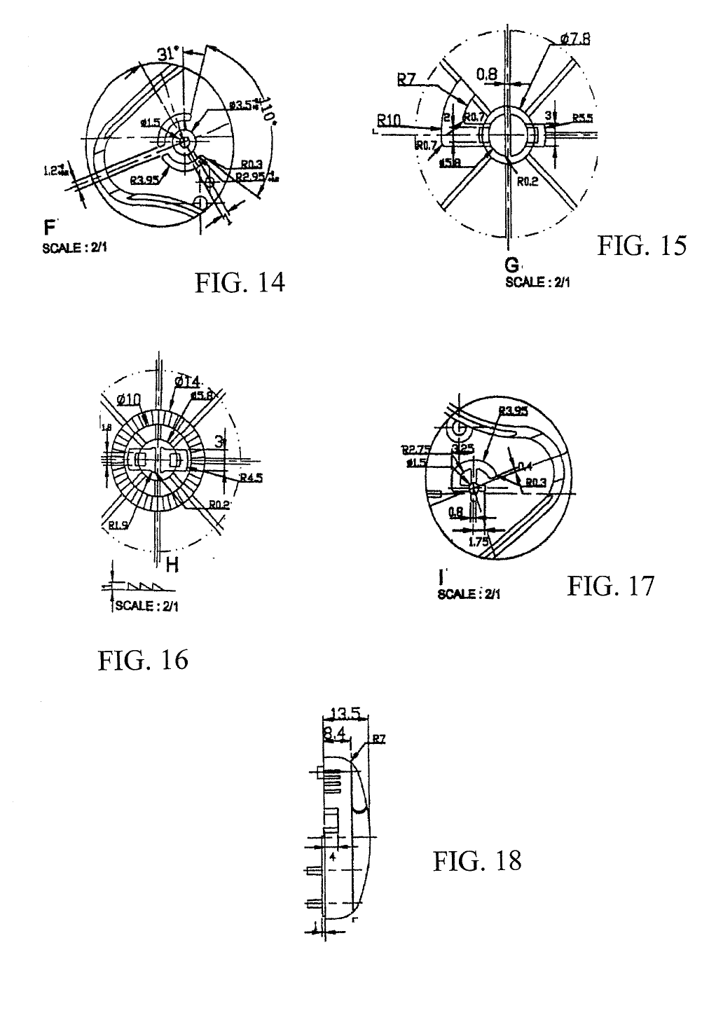

FIG. 14 is a close-up view of the “transfer tip” region marked “F” in FIG. 8. FIG. 17 is a close-up view of the “transfer tip” region marked “I” in FIG. 8. The transfer tapes roll across these two tip areas when engaged with paper and the transfer films are released by application of pressure at the tip to the paper.

FIG. 15 is a close-up view of the region marked “G” in FIG. 8. FIG. 16 is a close-up view of the region marked “H” in FIG. 8. These are the tape reels for delivery and take-up of the transfer film-backing sheet.

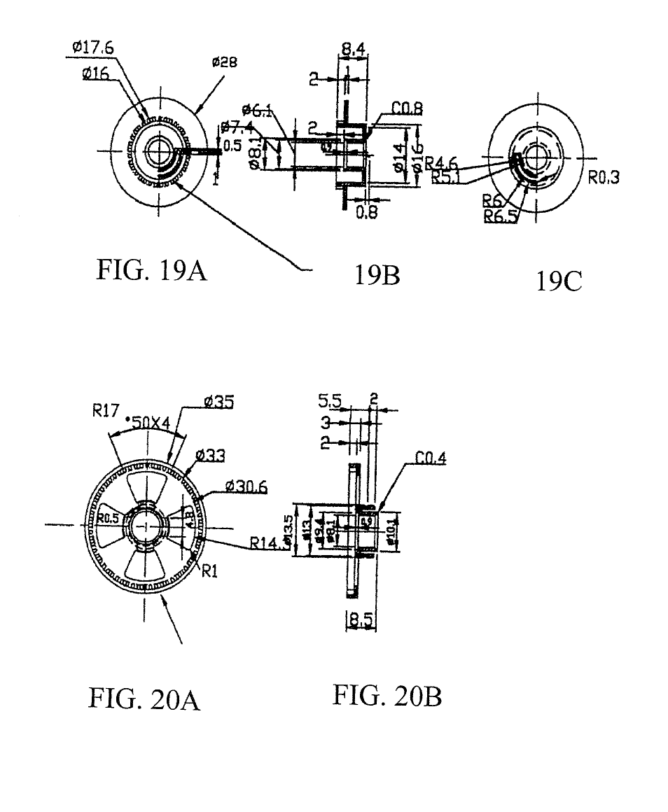

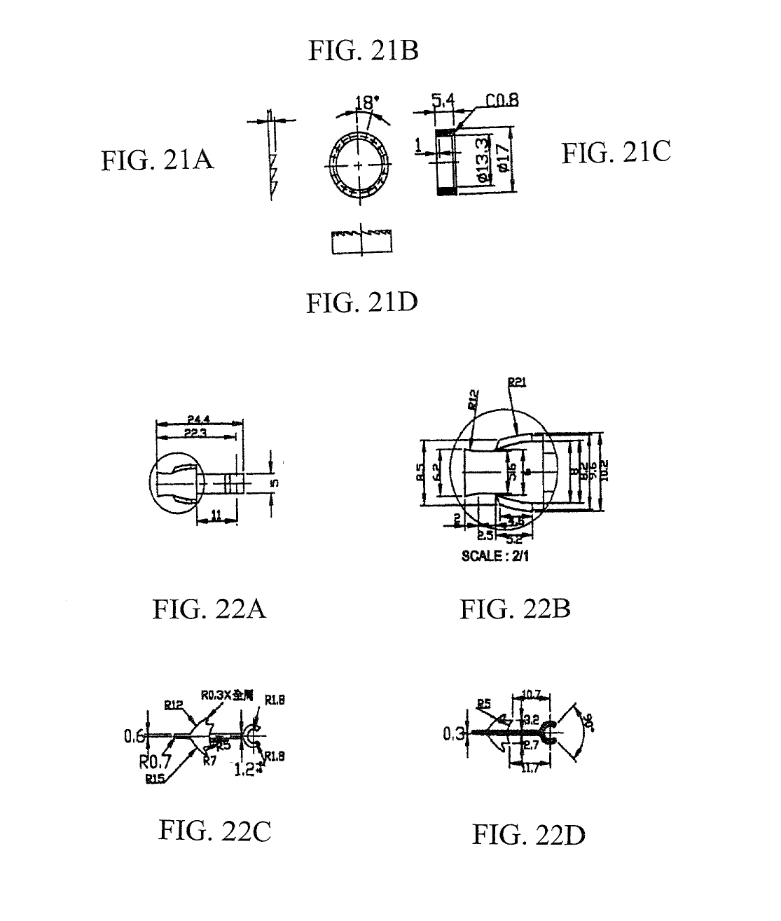

FIGS. 19A, 19B and 19C show details regarding internal components of the double-sided dispenser of the present invention. FIGS. 20A and 20B show details regarding internal components of the double-sided dispenser of the present invention. FIGS. 21A, 21B, 21C and 21D show details regarding internal components of the double-sided dispenser of the present invention. FIGS. 22A, 22B, 22C and 22D show details regarding internal components of the double-sided dispenser of the present invention.

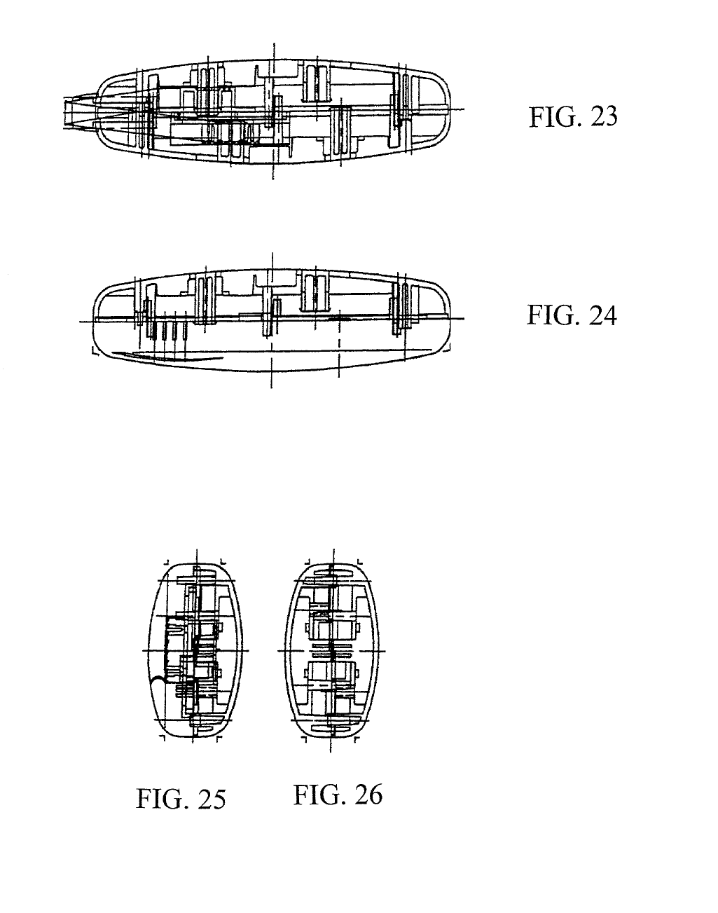

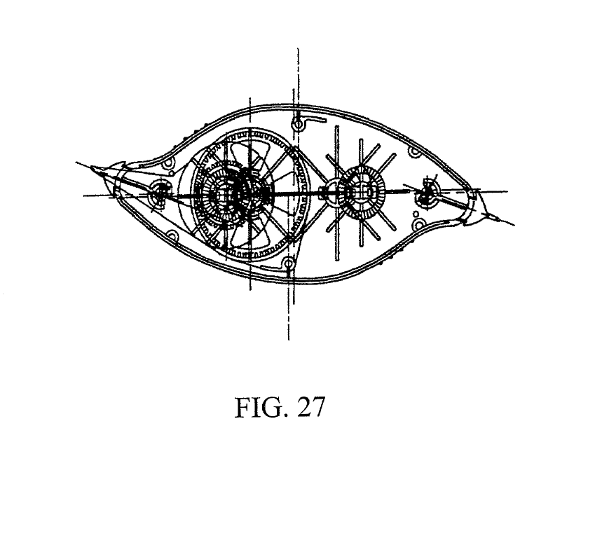

FIG. 23 is an X-ray view from the topside of the double-sided dispenser of the present invention. FIG. 24 is an X-ray view from the bottom side of the double-sided dispenser of the present invention. FIGS. 25 and 26 are X-ray views from each end of the double-sided dispenser of the present invention. FIG. 27 is an X-ray view from the flat side of the double-sided dispenser of the present invention.

The present invention has been described in detail, including the preferred embodiments thereof. However, it will be appreciated that those skilled in the art, upon consideration of the present disclosure, may make modifications and/or improvements on this invention and still be within the scope and spirit of this invention as set forth in the following claims.

What is claimed is:

1. A double-sided dispenser having two transfer film outlets, one for a correction film, the other for a highlighting film, substantially as described herein.

2. The double sided dispenser of claim 1, wherein the width of the two transfer films is substantially the same.

3. The double sided dispenser of claim 1, wherein the width of the two transfer films is not substantially the same.

4. A double-sided dispenser having two transfer film outlets, both for correction film, substantially as described herein.

5. The double sided dispenser of claim 4, wherein the width of the two transfer films is substantially the same.

6. The double sided dispenser of claim 4, wherein the width of the two transfer films is not substantially the same.

7. A double-sided dispenser having two transfer film outlets, both for a highlighting film, substantially as described herein.

8. The double sided dispenser of claim 7, wherein the width of the two transfer films is substantially the same.

9. The double sided dispenser of claim 7, wherein the width of the two transfer films is not substantially the same.
